(19) United States
(12) Patent Application Publication
(10) Pub. No.: US 2026/0225019 A1
(43) Pub. Date: Aug. 6, 2026

(54) Filter Support Mechanism, Filter Support Apparatus, and Filter Apparatus

(71) Applicant: Siemens Aktiengesellschaft, München (DE)

(72) Inventors: Ye Fei Yin, Nanjing (CN); Yu Jie Yang, Nanjing (CN)

(73) Assignee: Siemens Aktiengesellschaft, München (DE)

(21) Appl. No.: 19/149,649

(22) PCT Filed: Jan. 20, 2023
(86) PCT No.: PCT/CN2023/073445

§ 371 Date: Jul. 21, 2025

(51) Int. Cl. B01D 46/18; B01D 46/00; B01D 46/44

(52) U.S. Cl. CPC B01D 46/185; B01D 46/0005; B01D 46/44

(57) ABSTRACT

A filter support mechanism includes a first roller, a second roller, and a press-on part. The first roller is rotatable about an axis thereof with respect to a body. The second roller is rotatable about an axis thereof with respect to the body. The second roller is parallel to the axis of the first roller. The first roller and the second roller are respectively configured to roll two ends of a filter. A portion of the filter between the first roller and the second roller covers a first opening of the body. The press-on part is movable with respect to the body and is capable of moving to clamp the filter with the body, and a clamped part of the filter is in an annular shape surrounding the first opening. With the filter support mechanism, the filter may be conveniently replaced.

### CROSS-REFERENCE TO RELATED APPLICATIONS

This application is a U.S. National Stage Application of International Application No. PCT/CN2023/073445 filed Jan. 20, 2023, which designates the United States of America, the contents of which are hereby incorporated by reference in their entirety.

### TECHNICAL FIELD

The present disclosure relates to filters. Various embodiments of the teachings herein include filter support mechanisms, filter support apparatus, and filter apparatus.

### BACKGROUND

A driver is typically subject to complicated use environments, and excessive dust and fluff in the air. Once the dust and fluff in the air enter the driver, normal operation of the driver is affected. Configuring a filter at an air inlet of the driver helps to solve the above problem. The filter needs to be periodically replaced, to address irregular air flows due to blockage of mesh by the dust and fluff.

### SUMMARY

Teachings of the present disclosure provide filter support mechanisms which facilitate replacement of a filter. For example, some embodiments of the teachings herein include a filter support mechanism, mounted on a body (200) and configured to support a filter (300), the body (200) being provided with a first opening (201), the filter (300) being configured to filter a fluid flowing through the first opening (201), wherein the filter support mechanism comprises: a first roller (10), configured to be rotatable about an axis thereof with respect to the body (200); a second roller (20), configured to be rotatable about an axis thereof with respect to the body (200), wherein the axis of the second roller (20) is parallel to the axis of the first roller (10), the first roller (10) is configured to roll one end of the filter (300), the second roller (20) is configured to roll the other end of the filter (300), and mount positions of the first roller (10) and the second roller (20) are defined such that a portion of the filter (300) between the first roller (10) and the second roller (20) covers the first opening (201); and a press-on part (30), configured to be movable with respect to the body (200), wherein the press-on part (30) is capable of moving to clamp the filter (300) with the body (200), and a clamped part of the filter (300) is in an annular shape surrounding the first opening (201); the press-on part (30) is configured to be movable with respect to the body (200) along a first direction (D1) and a direction reverse to the first direction (D1), the first direction (D1) being perpendicular to a plane where both the axis of the first roller (10) and the axis of the second roller (20) are within; and wherein the filter support mechanism further comprises: a gear (41), the gear (41) being configured to be rotatable about an axis thereof with respect to the body (200), and the press-on part (30) further comprises a rack portion (33), the gear (41) and the rack portion (33) being engaged with each other to be capable of driving, by rotation of the gear (41), the press-on part (30) to move along the first direction (D1) and the direction reverse to the first direction (D1); a first drive motor (50) and a control unit (90), wherein the first drive motor (50) is capable of driving the gear (41) to rotate, and the control unit (90) is connected to the first drive motor (50) to control operation of the first drive motor (50).

In some embodiments, the body (200) is provided with an annular surface (202) surrounding the first opening (201), the axis of the first roller (10) is parallel to the annular surface (202), the press-on part (30) comprises a cover plate portion (31), the cover plate portion (31) being in a plate shape, and the press-on part (30) is capable of moving to the cover plate portion (31) to clamp the filter (300) in a mutually parallel posture with the annular surface (202).

In some embodiments, the cover plate portion (31) is in a mesh plate shape.

In some embodiments, the press-on part (30) further comprises a flap portion (32), wherein the flap portion (32) extends from an edge of the plate portion (31) along a direction perpendicular to the cover plate portion (31), and in the case that the cover plate portion (31) clamps the filter (300) with the annular surface (202), the flap portion (32) is capable of interacting with the body (200) to limit movement of the press-on part (30) with respect to the body (200) along a direction parallel to the cover plate portion (31).

In some embodiments, the filter support mechanism comprises four gears (41), wherein each two of the gears (41) form a support unit (40), the two gears (41) of each of the support units (40) are arranged along a second direction (D2), the second direction (D2) being perpendicular to the first direction (D1), and the two support units (40) are arranged along a direction perpendicular to the first direction (D1) and the second direction (D2); and wherein the press-on part (30) comprises four rack portions (33), wherein one of the rack portions (33) is engaged with one of the gears (41), the two gears (41) of each of the support units (40) are disposed on opposing sides or opposite sides of the two rack portions (33) engaged therewith along the second direction (D2) to prevent the press-on part (30) from moving with respect to the body (200) along the second direction (D2) or the direction reverse to the second direction (D2).

In some embodiments, the filter support mechanism further comprises: a second drive motor (60) and a control unit (90), wherein the second drive motor (60) is capable of driving the second roller (20) to rotate, and the control unit (90) is connected to the second drive motor (60) to control operation of the second drive motor (60).

In some embodiments, the filter support mechanism further comprises: a transmission mechanism (70), wherein the transmission mechanism (70) is connected to the second drive motor (60) and the second roller (20), the second drive motor (60) is capable of driving, by the transmission mechanism (70), the second roller (20) to rotate, and the transmission mechanism (70) is configured to be a synchronization belt transmission structure or chain transmission structure.

In some embodiments, the filter support mechanism further comprises: a damper (80), wherein the damper (80) is acted on the first roller (10) to increase a resistance against rotation of the first roller (10) towards a direction of unrolling the filter (300).

In some embodiments, the damper (80) is a damping spindle.

In some embodiments, the damper (80) is a spring, wherein the spring applies a rotation torque to the first roller (10) by elastic deformation to tension the portion of the filter (300) between the first roller (10) and the second roller (20).

As another example, some embodiments include a filter support apparatus comprising: a body (200), provided with a first opening 201; and a filter support mechanism as described herein, mounted on the body (200) and configured to support a filter (300) configured to filter a fluid flowing through the first opening (201), wherein the first roller (10) is configured to be rotatable about an axis thereof with respect to the body (200), the second roller (20) is configured to be rotatable about an axis thereof with respect to the body (200), the first roller (10) is configured to roll one end of the filter (300), the second roller (20) is configured to roll the other end of the filter (300), mount positions of the first roller (10) and the second roller (20) are defined such that a portion of the filter (300) between the first roller (10) and the second roller (20) covers the first opening (201), the press-on part (30) is configured to be movable with respect to the body (200), the press-on part (30) is capable of moving to clamp the filter (300) with the body (200), and a clamped part of the filter (300) is in an annular shape surrounding the first opening (201).

As another example, some embodiments include a filter apparatus comprising: a body (200), provided with a first opening (201); a filter (300), configured to filter a fluid flowing through the first opening (201); and a filter support mechanism as described herein, mounted on the body (200) and configured to support the filter (300), wherein the first roller (10) is configured to be rotatable about an axis thereof with respect to the body (200), the second roller (20) is configured to be rotatable about an axis thereof with respect to the body (200), one end of the filter (300) is rolled on the first roller (10), the other end of the filter (300) is rolled on the second roller (20), a portion of the filter (300) between the first roller (10) and the second roller (20) covers the first opening (201), the press-on part (30) is configured to be movable with respect to the body (200), the press-on part (30) is capable of moving to clamp the filter (300) with the body (200), and a clamped part of the filter (300) is in an annular shape surrounding the first opening (201).

### BRIEF DESCRIPTION OF THE DRAWINGS

The accompanying drawings are merely for schematic and illustrative description and demonstration of the teachings of the present disclosure, instead of limiting the scope thereof. In the drawings:

FIG. 1 is a schematic structural view of an example filter support mechanism incorporating teachings of the present disclosure;

FIG. 2 is an exploded view of the filter support mechanism as illustrated in FIG. 1;

FIG. 3 is a schematic partial structural view of the filter support mechanism as illustrated in FIG. 1;

FIG. 4 is a schematic structural view of a press-on part of the filter support mechanism as illustrated in FIG. 1;

FIG. 5 is a schematic structural view of an example filter support mechanism incorporating teachings of the present disclosure; and

FIG. 6 is a schematic structural view of an example filter support apparatus incorporating teachings of the present disclosure.

### REFERENCE NUMERALS AND DENOTATIONS THEREOF

100—filter support mechanism
10—first roller
20—second roller
30—press-on part
31—cover plate portion
311—mesh
32—flap portion
33—rack portion
40—support unit
41—gear
50—first drive motor
60—second drive motor
70—transmission mechanism
71—synchronization wheel
72—synchronization belt
80—damper
90—control unit
200—body
201—first opening
202—annular surface
203—second opening
300—filter
D1—first direction
D2—second direction
D3—third direction

### DETAILED DESCRIPTION

Some embodiments of the present disclosure include a filter support mechanism mounted on a body and configured to support a filter. In some embodiments, the body is provided with a first opening. The filter is configured to filter the fluid flowing through the first opening. The filter support mechanism includes a first roller, a second roller, and a press-on part. The first roller is configured to be rotatable about an axis thereof with respect to the body. The second roller is configured to be rotatable about an axis thereof with respect to the body, and an axis of the second roller is parallel to the axis of the first roller. The first roller is configured to roll one end of the filter, and the second roller is configured to roll the other end of the filter. Mount positions of the first roller and the second roller are defined such that a portion of the filter between the first roller and the second roller covers the first opening. The press-on part is configured to be movable with respect to the body. The press-on part is capable of moving to clamp the filter with the body, and a clamped part of the filter is in an annular shape surrounding the first opening.

In some embodiments, the filter support mechanism unrolls and rolls the filter by rotating the first roller and the second roller. By such operations, a portion of the filter opposite to the first opening may be replaced. In this way, the filter may be conveniently replaced. In addition, by configuration of the press-on part, the filter is capable of being clamped between the press-on part and the body. In this way, during the filtering, a poor filtering effect due to a slit between the filter and the body caused by deformation of the filter is avoided.

In some embodiments, the body is provided with an annular surface surrounding the first opening. The axis of the first roller is parallel to the annular surface. The press-on part includes a cover plate portion. The cover plate portion is in a plate shape. The press-on part is capable of moving to the cover plate portion to clamp the filter in a mutually parallel posture with the annular surface. This structure is simple and achieves a better press-on effect.

In some embodiments, the cover plate portion is in a mesh plate shape. In this way, it is favorable to protecting the filter.

In some embodiments, the press-on part further includes a flap portion. The flap portion extends from an edge of the cover plate portion along a direction perpendicular to the cover plate portion. In the case that the cover plate portion clamps the filter with the annular surface, the flap portion is capable of interacting with the body to limit movement of the press-on part with respect to the body along a direction parallel to the cover plate portion. In this way, it is favorable to improving stability of the mechanism in use.

In some embodiments, the press-on part is configured to be movable with respect to the body along a first direction and a direction reverse to the first direction, wherein the first direction is perpendicular to a plane where both the axis of the first roller and the axis of the second roller are within. The filter support mechanism further includes a gear. The gear is configured to be rotatable about an axis thereof with respect to the body. The press-on part further includes a rack portion. The gear and the rack portion are engaged with each other to be capable of driving, by rotation of the gear, the press-on part to move along the first direction and the direction reverse to the first direction. In this way, by virtue of the rotation torque, the press-on part is driven to linearly move.

In some embodiments, the filter support mechanism further includes a first drive motor and a control unit. The first drive motor is capable of driving the gear to rotate. The control unit is connected to the first drive motor to control operation of the first drive motor. In this way, it is favorable to achieving automatic operation of the mechanism.

In some embodiments, the filter support mechanism includes four gears. Each two of the gears form a support unit. The two gears of each of the support units are arranged along a second direction, wherein the second direction is perpendicular to the first direction. The two support units are arranged along a direction perpendicular to the first direction and the second direction. The press-on part includes four rack portions. One of the rack portions is engaged with one of the gears. The two gears of each of the support units are disposed on opposing sides or opposite sides of the two rack portions engaged therewith along the second direction to prevent the press-on part from moving with respect to the body along the second direction or the direction reverse to the second direction. In this way, the entire structure is more compact.

In some embodiments, the filter support mechanism further includes a second drive motor and a control unit. The second drive motor is capable of driving the second roller to rotate. The control unit is connected to the second drive motor to control operation of the second drive motor. In this way, it is favorable to achieving automatic operation of the mechanism.

In some embodiments, the filter support mechanism further includes a transmission mechanism. The transmission mechanism is connected to the second drive motor and the second roller. The second drive motor is capable of driving, by the transmission mechanism, the second roller to rotate. The transmission mechanism is configured to be a synchronization belt transmission structure or a chain transmission structure. By configuration transmission mechanism, torque adjustment and space arrangement are facilitated.

In some embodiments, the filter support mechanism further includes a damper. The damper is acted on the first roller to increase a resistance against rotation of the first roller towards a direction of unrolling the filter. In this way, it is favorable to tensioning the portion of the filter between the first roller and the second roller.

In some embodiments, the damper is a damping spindle. This structure has better stability.

In some embodiments, the damper is a spring, wherein the spring applies a rotation torque to the first roller by elastic deformation to tension the portion of the filter between the first roller and the second roller. This structure is simple and may be favorable to reducing the cost.

Some embodiments of the present disclosure include a filter support apparatus with a body and a filter support mechanism as described herein. The body is provided with a first opening. The filter support mechanism is mounted on the body and is configured to support a filter configured to filter a fluid flowing through the first opening. The first roller is configured to be rotatable about an axis thereof with respect to the body. The second roller is configured to be rotatable about an axis thereof with respect to the body. The first roller is configured to roll one end of the filter, and the second roller is configured to roll the other end of the filter. Mount positions of the first roller and the second roller are defined such that a portion of the filter between the first roller and the second roller covers the first opening. The press-on part is configured to be movable with respect to the body. The press-on part is capable of moving to clamp the filter with the body, and a clamped part of the filter is in an annular shape surrounding the first opening. With the filter support apparatus, the filter may be conveniently replaced. In addition, by configuration of the press-on part, the filter is capable of being clamped between the press-on part and the body. In this way, during the filtering, a poor filtering effect due to a slit between the filter and the body caused by deformation of the filter is avoided.

Some embodiments of the present disclosure include a filter apparatus with a body, a filter, and a filter support mechanism as described herein. The body is provided with a first opening. The filter is configured to filter the fluid flowing through the first opening. The filter support mechanism is mounted on the body, and is configured to support the filter. The first roller is configured to be rotatable about an axis thereof with respect to the body. The second roller is configured to be rotatable about an axis thereof with respect to the body. One end of the filter is rolled on the first roller, and the other end of the filter is rolled on the second roller. A portion of the filter between the first roller and the second roller covers the first opening. The press-on part is configured to be movable with respect to the body. The press-on part is capable of moving to clamp the filter with the body, and a clamped part of the filter is in an annular shape surrounding the first opening. With the filter apparatus, the filter may be conveniently replaced. In addition, by configuration of the press-on part, the filter is capable of being clamped between the press-on part and the body. In this way, during the filtering, a poor filtering effect due to a slit between the filter and the body caused by deformation of the filter is avoided.

For clearer descriptions of the technical features, objects, and the effects of the teachings of the present disclosure, some example embodiments are hereinafter described with reference to the accompanying drawings. In the drawings, like reference numerals denote elements having the same structure or having the similar structure but the same function.

In this text, the term “exemplary” or “schematic” is used herein to mean “serving as an example, instance, or illustration,” and any illustration or embodiment described herein as “exemplary” shall not be necessarily construed as preferred or advantageous over other illustrations or embodiments.

In this text, the terms “first,” “second,” and the like do not represent degrees of importance or a sequence, but only for differentiation, and for ease of description.

For brevity, parts relevant to the present disclosure are merely illustrated in the drawings, and these parts do not denote the actual structure of the product.

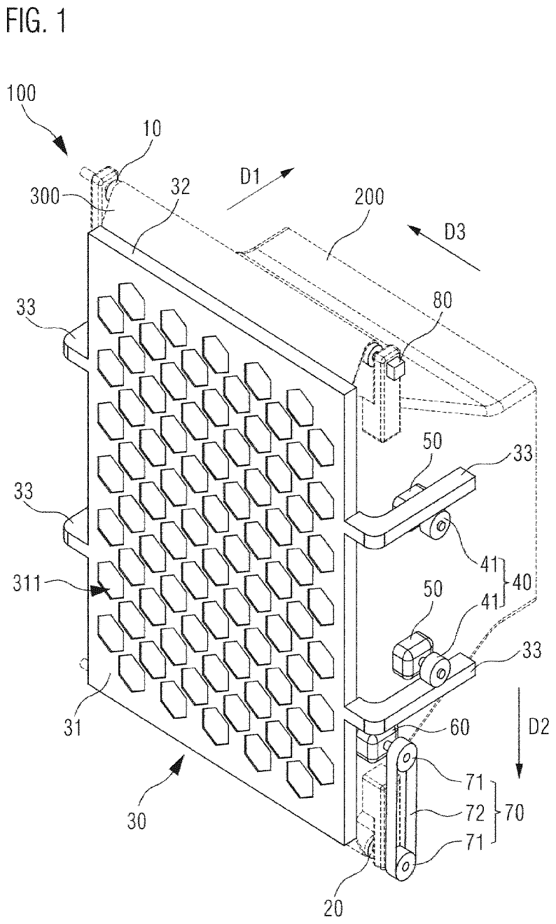

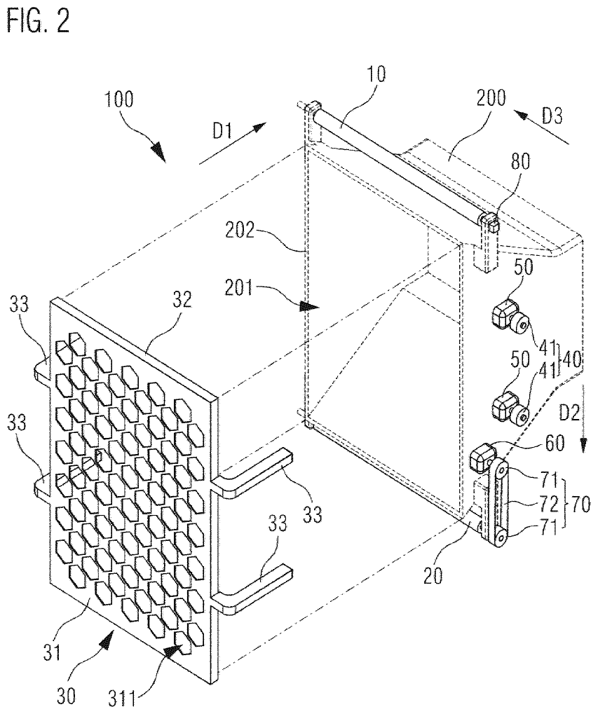

FIG. 1 is a schematic structural view of an example filter support mechanism incorporating teachings of the present disclosure. FIG. 2 is an exploded view of the filter support mechanism as illustrated in FIG. 1. As illustrated in FIG. 1, a filter support mechanism 100 is mounted on a body 200 and is configured to support a filter 300. As illustrated in FIG. 2, the body 200 is provided with a first opening 201. The filter 300 is configured to filter a fluid flowing through the first opening 201.

As illustrated in FIG. 1 and FIG. 2, the filter support mechanism 100 includes a first roller 10, a second roller 20, and a press-on part 30.

The first roller 10 is configured to be rotatable about an axis thereof with respect to the body 200. The second roller 20 is configured to be rotatable about an axis thereof with respect to the body 200, and an axis of the second roller 20 is parallel to the axis of the first roller 10. In this exemplary embodiment, as illustrated in FIG. 1 and FIG. 2, the axis of the first roller 10 and the axis of the second roller 20 are both parallel to a third direction D3. The first roller 10 is configured to roll one end of the filter 300, and the second roller 20 is configured to roll the other end of the filter 300. Mount positions of the first roller 10 and the second roller 20 are defined such that a portion of the filter 300 between the first roller 10 and the second roller 20 covers the first opening 201. Specifically, as illustrated in FIG. 1 and FIG. 2, the first roller 10 and the second roller 20 are respectively disposed on two sides of the first opening 201 along a second direction D2.

The press-on part 30 is configured to be movable with respect to the body 200. Specifically, in this exemplary embodiment, the press-on part 30 is configured to be movable with respect to the body 200 along a first direction D1 and a direction reverse to the first direction D1, wherein the first direction D1 is perpendicular to a plane where both the axis of the first roller 10 and the axis of the second roller 20 are within, which is not limited herein.

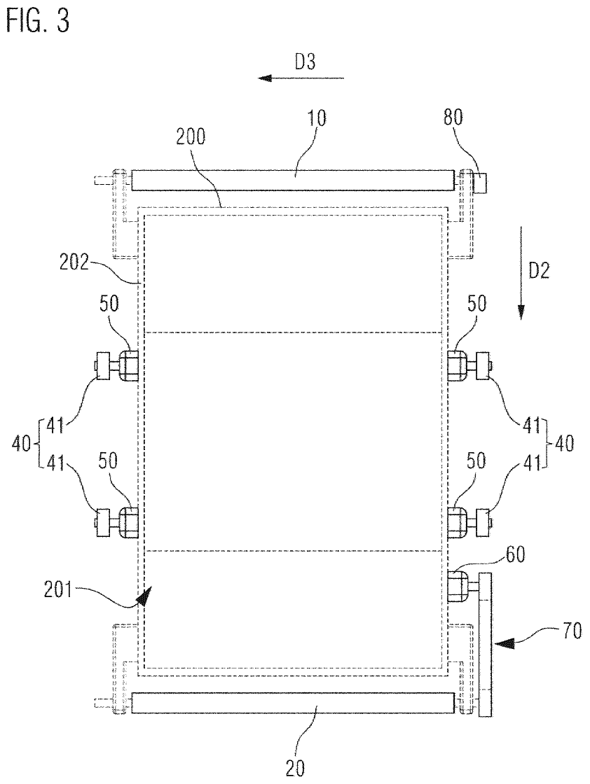

FIG. 3 is a schematic partial structural view of the filter support mechanism as illustrated in FIG. 1. As illustrated in FIG. 3, in this exemplary embodiment, the filter support mechanism 100 further includes four gears 41. Each of the gears 41 is configured to be rotatable about an axis thereof with respect to the body 200. Each two of the gears 41 form a support unit 40. The two gears 41 of each of the support units 40 are arranged along the second direction D2. The two support units 40 are arranged along a third direction D3 perpendicular to the first direction D1 and the second direction D2.

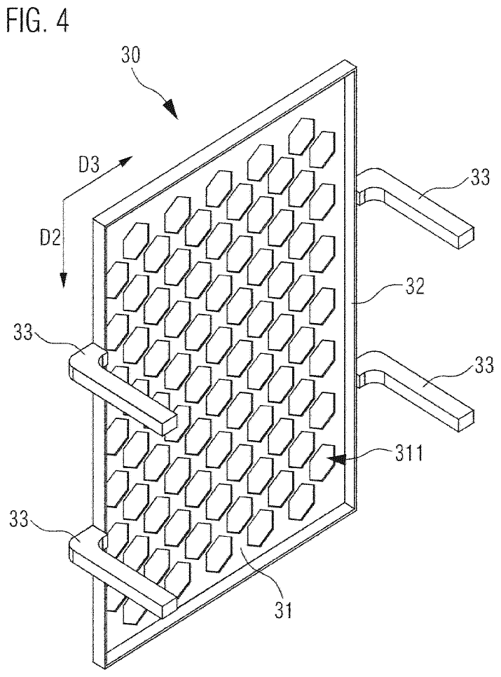

FIG. 4 is a schematic structural view of an example press-on part of the filter support mechanism as illustrated in FIG. 1. As illustrated in FIG. 4, in this exemplary embodiment, the press-on part 30 includes four rack portions 33. As illustrated in FIG. 1, one of the rack portions 33 is engaged with one of the gears 41, such that the press-on part 30 is driven, by rotation of the gears 41, to move along the first direction D1 and the direction reverse to the first direction D1. The two gears 41 of each of the support units 40 are disposed on opposing sides of the two rack portions 33 engaged therewith along the second direction D2 to prevent the press-on part 30 from moving with respect to the body 200 along the second direction D2 or the direction reverse to the second direction D2. In other exemplary embodiments, the two gears 41 of each of the support units 40 may also be disposed on opposite sides of the two rack portions 33 engaged therewith along the second direction D2. In this way, the press-on part 30 may also be prevented from moving with respect to the body 200 along the second direction D2 or the direction reverse to the second direction D2.

In this exemplary embodiment, the press-on part 30 is movably connected to the body 200 by the four gears 41 and the four rack portions 33, which is not limited thereto. In other exemplary embodiments, the press-on part 30 may also be movably connected to the body 200 by other structures. These structures include, but are not limited to, a rail structure. Based on this, by configuring a gear 41 and a rack portion 33, the press-on part 30 is driven, by rotation of the gear 41, to move. Nevertheless, in other exemplary embodiments, the press-on part 30 may be driven, by other structures, to move.

The press-on part 30 is capable of moving to clamp the filter with the body 200, and a clamped part of the filter 300 is in an annular shape surrounding the first opening 201. Specifically, in this exemplary embodiment, as illustrated in FIG. 2, the body 200 is provided with an annular surface 202 surrounding the first opening 201. The axis of the first roller 10 is parallel to the annular surface 202. The press-on part 30 includes a cover plate portion 31. The cover plate portion 31 is in a plate shape. The press-on part 300 is capable of moving to the cover plate portion 31 to clamp the filter 300 in a mutually parallel posture with the annular surface 202. In this way, an annular portion of the filter 300 opposite to the annular surface 202 is clamped by the cover plate 31 and the body 200 and thus fixed. FIG. 1 illustrates a state where the filter 300 is clamped.

A structure allowing the fluid to flow through is disposed at the center of the cover plate portion 31. As illustrated in FIG. 1, FIG. 2, and FIG. 4, in this exemplary embodiment, the cover plate portion 31 is in a mesh plate shape and is provided with a plurality of meshes 311, such that the filter 300 is protected, which is not limited thereto. In other exemplary embodiments, the cover plate portion 31 may also be a large hole opened in the center.

With the filter support mechanism, the filter may be, for example, replaced as follows: First, the press-on part 30 is moved to detach from the position of the filter 300. Then, the first roller 10 and the second roller 20 are rotated to replace the portion of the filter 300 opposite to the first opening 201. Upon completion of replacement, the press-on part 30 is move back to the position where the press-on part clamps the filter 300 with the body 200.

During use, the filter support mechanism unrolls and rolls the filter 300 by rotating the first roller 10 and the second roller 20. By such operations, a portion of the filter 300 opposite to the first opening 201 may be replaced. In this way, the filter 300 may be conveniently replaced. It should be noted that “replacement of the filter” herein refers to replacing the portion of the filter opposite to the first opening, other than removing the entire filter from the filter support mechanism and loading another filter to the filter support mechanism.

In addition, by configuration of the press-on part 30, the filter 300 is capable of being clamped between the press-on part 39 and the body 200. In this way, during the filtering, a poor filtering effect due to a slit between the filter 300 and the body 200 caused by deformation of the filter 300 is avoided.

As illustrated in FIG. 1, FIG. 2, and FIG. 4, in this exemplary embodiment, the press-on part 30 further includes a flap portion 32. The flap portion 32 extends from an edge of the cover plate portion 31 along a direction perpendicular to the cover plate portion 31. In this exemplary embodiment, the flap portion 32 is in an annular shape surrounding the cover plate portion 31, which is not limited thereto. In the case that the cover plate portion 31 clamps the filter 300 with the annular surface 202, the flap portion 32 is capable of interacting with the body 200 to limit movement of the press-on part 30 with respect to the body 200 along a direction parallel to the cover plate portion 31. In this way, it is favorable to improving stability of the mechanism in use.

As illustrated in FIG. 1 to FIG. 3, in this exemplary embodiment, the filter support mechanism 100 further includes four first drive motors 50. Each of the first drive motors 50 is capable of driving one of the gears 41 to rotate. In this way, the operation is eased, which is not limited thereto. In other exemplary embodiments, the first drive motor 50 may not be configured, and the gears 41 is manually driven to rotate.

As illustrated in FIG. 1 to FIG. 3, in this exemplary embodiment, the filter support mechanism 100 further includes a second drive motor 60 and a transmission mechanism 70. The transmission mechanism 70 is connected to the second drive motor 60 and the second roller 20. The second drive mechanism 60 is capable of driving, by the transmission mechanism 70, the second roller 20 to rotate. In this exemplary embodiment, the transmission mechanism 70 is configured to a synchronization belt transmission structure, and includes two synchronization wheels 71 and one synchronization belt 72. The two synchronization wheels 71 are respectively fixed to an output shaft of the second drive motor 60 and the second roller 20, and the synchronization belt 72 is wound on the two synchronization wheels 71. In other exemplary embodiments, the transmission mechanism 70 may also be configured to another structure capable of practicing synchronous actions between the second drive motor 60 and the second roller 20, including, but not limited to, a chain transmission structure. By configuration of the second drive motor 60, the operation is eased, which is not limited thereto. In other exemplary embodiments, the second drive motor 60 may not be configured, and the second roller 20 is manually driven to rotate. By configuration of the transmission mechanism 70, torque adjustment and space arrangement are facilitated, which is not limited thereto. In other exemplary embodiments, the transmission mechanism 70 may not be configured, and the second roller 20 is directly driven, by the second drive motor 60, to rotate.

As illustrated in FIG. 1 and FIG. 2, in an exemplary embodiment, the filter support mechanism 100 further includes a damper 80. The damper 80 is acted on the first roller 10 to increase a resistance against rotation of the first roller 10 towards a direction of unrolling the filter 300. In this way, it is favorable to tensioning the portion of the filter 300 between the first roller 10 and the second roller 20. Specifically, in an exemplary embodiment, the damper 80 is a damping spindle. In other exemplary embodiments, the damper 80 may also be a spring, wherein the spring applies a rotation torque to the first roller 10 by elastic deformation to tension the portion of the filter 300 between the first roller 10 and the second roller 20.

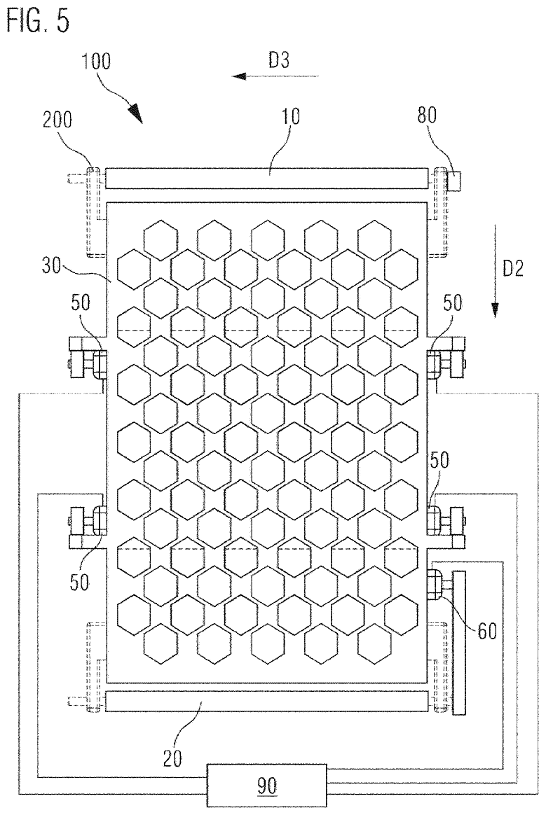

FIG. 5 is a schematic structural view of another example filter support mechanism incorporating teachings of the present disclosure. The common or similar points between the filter support mechanism according to this exemplary embodiment and the filter support mechanism as illustrated in FIG. 1 are not described herein any further, and the differences between these two filter support mechanisms are described hereinafter. In this exemplary embodiment, the filter support mechanism 100 further includes a control unit 90. The control unit 90 is connected to the first drive motor 50 and the second drive motor 60 to control operation of the first drive motor 50 and the second drive motor 60. By configuration of the control unit 90, automatic operation of the first drive motor 50 and the second drive motor 60 may be practiced. For example, periodic replacement of the filter is automatically practiced by defining a program in the control unit 90.

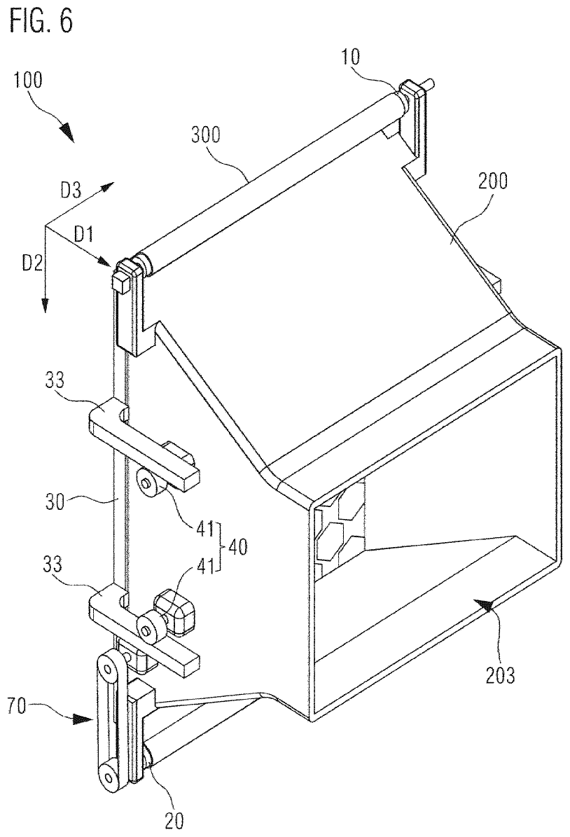

Some embodiments of the teachings herein include a filter support apparatus. FIG. 6 is a schematic structural view of an example filter support apparatus incorporating teachings of the present disclosure. As illustrated in FIG. 1 and FIG. 6, the filter support apparatus includes a body 200 and the filter support mechanism 100 as illustrated in FIG. 1. The body 200 is provided with a first opening 201 and a second opening 203. The first opening 201 and the second opening 203 are communicated via a passage. The second opening 203, for example, is configured to be communicated with an air inlet of another apparatus. The another apparatus may be, for example, a driver. The filter support mechanism 100 is mounted on the body 200, and is configured to support a filter 300 configured to filter a fluid flowing through the first opening 201. The first roller 10 is configured to be rotatable about an axis thereof with respect to the body 200. The second roller 20 is configured to be rotatable about an axis thereof with respect to the body 200. The first roller 10 is configured to roll one end of the filter 300, and the second roller 20 is configured to roll the other end of the filter 300. Mount positions of the first roller 10 and the second roller 20 are defined such that a portion of the filter 300 between the first roller 10 and the second roller 20 covers the first opening 201. The press-on part 30 is configured to be movable with respect to the body 200. The press-on part 30 is capable of moving to clamp the filter with the body 200, and a clamped part of the filter 300 is in an annular shape surrounding the first opening 201. With the filter support apparatus, the filter may be conveniently replaced. It should be noted that “replacement of the filter” herein refers to replacing the portion of the filter opposite to the first opening, other than removing the entire filter from the filter support mechanism and loading another filter to the filter support mechanism. In addition, by configuration of the press-on part 30, the filter 300 is capable of being clamped between the press-on part 39 and the body 200. In this way, during the filtering, a poor filtering effect due to a slit between the filter 300 and the body 200 caused by deformation of the filter 300 is avoided.

Some embodiments of the teachings herein include a filter apparatus. As illustrated in FIG. 1 and FIG. 6, the filter apparatus includes a body 200, a filter 300, and the filter support mechanism 100 as illustrated in FIG. 1. The body 200 is provided with a first opening 201 and a second opening 203. The first opening 201 and the second opening are communicated via a passage. The second opening 203, for example, is configured to be communicated with an air inlet of another apparatus. The another apparatus may be, for example, a driver. The filter 300 is configured to filter the fluid flowing through the first opening 201. The filter support mechanism 100 is mounted on the body 200, and is configured to support the filter 300. The first roller 10 is configured to be rotatable about an axis thereof with respect to the body 200. The second roller 20 is configured to be rotatable about an axis thereof with respect to the body 200. One end of the filter 300 is rolled on the first roller 10, and the other end of the filter 300 is rolled on the second roller 20. A portion of the filter 300 between the first roller 10 and the second roller 20 covers the first opening 201. The press-on part 30 is configured to be movable with respect to the body 200. The press-on part 30 is capable of moving to clamp the filter with the body 200, and a clamped part of the filter 300 is in an annular shape surrounding the first opening 201. With the filter apparatus, the filter may be conveniently replaced. It should be noted that “replacement of the filter” herein refers to replacing the portion of the filter opposite to the first opening, other than removing the entire filter from the filter support mechanism and loading another filter to the filter support mechanism. In addition, by configuration of the press-on part 30, the filter 300 is capable of being clamped between the press-on part 39 and the body 200. In this way, during the filtering, a poor filtering effect due to a slit between the filter 300 and the body 200 caused by deformation of the filter 300 is avoided.

It should be understood that, although this specification is described based on the embodiments, not each of the embodiments discloses an independent technical solution. Such description manner of the specification is only for clarity. A person skilled in the art should consider the specification as an entirety. The technical solutions according to the embodiments may also be suitably combined to derive other embodiments that may be understood by a person skilled in the art.

A series of detailed descriptions given in this specification are merely intended to illustrate feasible embodiments of the present disclosure, instead of limiting the protection scope of the present disclosure. Any equivalent embodiments or modifications, for example, combinations, segmentations, or repetition of features, derived without departing from the spirit of the present disclosure shall fall within the protection scope of the present disclosure.

What is claimed is:

1-14. (canceled)

15. A filter support mechanism, mounted on a body to support a filter, the body defining a first opening, the filter for a fluid flowing through the first opening, the filter support mechanism comprising:
a first roller to rotate about an axis thereof with respect to the body;
a second roller to rotate about an axis thereof with respect to the body;
wherein the axis of the second roller is parallel to the axis of the first roller;
the first roller rolls one end of the filter;
the second roller rolls a second end of the filter; and
a portion of the filter extending between the first roller and the second roller covers the first opening; and
a press-on part movable with respect to the body, wherein the press-on part moves to clamp the filter against the body in an annular shape surrounding the first opening;
wherein the press-on part moves with respect to the body along a first direction and a second direction reverse to the first direction, the first direction perpendicular to a plane where both the axis of the first roller and the axis of the second roller are within; and
a gear to rotate about an axis thereof with respect to the body;
wherein the press-on part further comprises a rack portion;
the gear and the rack portion engage with each other to drive the press-on part to move along the first direction and the second direction by rotation of the gear;
a first drive motor; and
a control unit;
wherein the first drive motor drives the gear to rotate; and
the control unit controls operation of the first drive motor.

16. The filter support mechanism according to claim 15, wherein:
the body has an annular surface surrounding the first opening;
the axis of the first roller is parallel to the annular surface;
the press-on part comprises a cover plate portion having a plate shape; and
the press-on part moves to the cover plate portion to clamp the filter parallel to the annular surface.

17. The filter support mechanism according to claim 16, wherein the cover plate portion comprises a mesh plate.

18. The filter support mechanism according to claim 16, wherein:
the press-on part further comprises a flap portion;
the flap portion extends from an edge of the cover plate portion along a direction perpendicular to the cover plate portion; and
when the cover plate portion clamps the filter to the annular surface, the flap portion interacts with the body to limit movement of the press-on part with respect to the body along a third direction parallel to the cover plate portion.

19. The filter support mechanism according to claim 15, further comprising four gears in two sets of two gears;
each set of gears forms a support unit wherein the two gears of each support unit are arranged along a third direction perpendicular to the first direction;
the two support units are arranged along a fourth direction perpendicular to the first direction and the third direction;
the press-on part comprises four rack portions;
one of the four rack portions is engaged with one of the four gears;
the two gears of each support unit are disposed on opposing sides of the two rack portions engaged therewith to prevent the press-on part from moving with respect to the body along the third direction or the direction reverse to the third direction.

20. The filter support mechanism according to claim 15, further comprising:
a second drive motor; and
a control unit;
wherein the second drive motor drives the second roller to rotate; and
the control unit controls operation of the second drive motor.

21. The filter support mechanism according to claim 20, further comprising a transmission mechanism connected to the second drive motor and the second roller;
wherein the second drive motor drives the second roller (20) to rotate through the transmission mechanism; and
the transmission mechanism comprises a synchronization belt transmission structure or a chain transmission structure.

22. The filter support mechanism according to claim 15, further comprising a damper acting on the first roller to increase a resistance against rotation of the first roller to unroll the filter.

23. The filter support mechanism according to claim 22, wherein the damper comprises a damping spindle.

24. The filter support mechanism according to claim 22, wherein:
the damper comprises a spring; and
the spring applies a rotation torque to the first roller by elastic deformation to pull the portion of the filter between the first roller and the second roller.

25. A filter support apparatus comprising:
a body having a first opening; and
filter support mechanism mounted on the body to support a filter for a fluid flowing through the first opening, the filter support mechanism comprising:
a first roller to rotate about an axis thereof with respect to the body;
a second roller to rotate about an axis thereof with respect to the body;
wherein the axis of the second roller is parallel to the axis of the first roller;
the first roller rolls one end of the filter;
the second roller rolls a second end of the filter; and
a portion of the filter extending between the first roller and the second roller covers the first opening; and
a press-on part movable with respect to the body, wherein the press-on part moves to clamp the filter against the body in an annular shape surrounding the first opening;
wherein the press-on part moves with respect to the body along a first direction and a second direction reverse to the first direction, the first direction perpendicular to a plane where both the axis of the first roller and the axis of the second roller are within; and
a gear to rotate about an axis thereof with respect to the body;
wherein the press-on part further comprises a rack portion;
the gear and the rack portion engage with each other to drive the press-on part to move along the first direction and the second direction by rotation of the gear;
a first drive motor; and
a control unit;
wherein the first drive motor drives the gear to rotate; and
the control unit controls operation of the first drive motor.

26. A filter apparatus comprising:
a body defining a first opening;
a filter to filter a fluid flowing through the first opening; and
filter support mechanism, mounted on a body to support a filter, the body defining a first opening, the filter for a fluid flowing through the first opening, the filter support mechanism comprising:
a first roller to rotate about an axis thereof with respect to the body;
a second roller to rotate about an axis thereof with respect to the body;
wherein the axis of the second roller is parallel to the axis of the first roller;
the first roller rolls one end of the filter;
the second roller rolls a second end of the filter; and
a portion of the filter extending between the first roller and the second roller covers the first opening; and
a press-on part movable with respect to the body, wherein the press-on part moves to clamp the filter against the body in an annular shape surrounding the first opening;
wherein the press-on part moves with respect to the body along a first direction and a second direction reverse to the first direction, the first direction perpendicular to a plane where both the axis of the first roller and the axis of the second roller are within; and
a gear to rotate about an axis thereof with respect to the body;
wherein the press-on part further comprises a rack portion;
the gear and the rack portion engage with each other to drive the press-on part to move along the first direction and the second direction by rotation of the gear;
a first drive motor; and
a control unit;
wherein the first drive motor drives the gear to rotate; and
the control unit controls operation of the first drive motor.
